(19) United States
(12) Patent Application Publication
(10) Pub. No.: US 2008/0266314 A1
(43) Pub. Date: Oct. 30, 2008

(54) Nonlinearly extending a color gamut of an image

(76) Inventor: Mark Melvin Butterworth, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/790,673

(22) Filed: Apr. 26, 2007

(51) Int. Cl. G09G 5/02

(52) U.S. Cl. 345/590

(57) ABSTRACT

Color management for extending a received color gamut for display. The received color gamut is expanded by applying a gain to color components. The applied gain varies depending on the saturation of the color component. Highly saturated colors in the received color gamut may accordingly be modified to a larger extent than less saturated colors to increase the vividness of highly saturated colors to the edges of the display's color gamut, while less saturated colors, such as memory colors, receive less gain and therefore are maintained as the same or similar to their original color.

### BACKGROUND

1. Field of the Invention

The present invention relates generally to color management, and more particularly, to nonlinearly extending a color gamut of an image.

2. Related Art

When viewing an image, a video or other static or dynamic display element (collectively and generally referred to herein as an “image”), users often prefer to experience bright and vivid colors. As display technology advances, new displays are able to support such brighter and more vivid colors. For example, new liquid-crystal displays (LCDs) may implement light-emitted diode (LED) or high quality fluorescent backlighting which provide better red and blue colors than existing fluorescent or incandescent light sources.

When image signals are transmitted to a display, the possible colors that may be contained in the image are within a color gamut associated with that signal. A color gamut refers to a subset of colors, such as, for example, the range of colors capable of being reproduced on a display device or the range of colors capable of being represented when encoding or processing an image. Images, however, are often transmitted using a color gamut that does not take full advantage of the improved color gamuts of these new displays. For example, due to television broadcasting limitations, the color gamut used to encode the images for transmission often has a significantly smaller range than the color gamut of these new displays.

### SUMMARY

In one aspect of the present invention, a method for managing colors for a display is disclosed. The method comprises: receiving a signal corresponding to an image to be displayed, the received signal comprising a color component having a color value, determining a gain based on the color value, and generating a modified color value for the color component by applying the determined gain to the color value. The image is displayed using the modified color value.

### BRIEF DESCRIPTION OF THE DRAWINGS

Embodiments of the present invention will be described in conjunction with the accompanying drawings, in which:

FIG. 1 illustrates two exemplary color gamuts in accordance with an embodiment of the present invention;

FIG. 2 is a functional block diagram of a display device in accordance with an embodiment of the present invention;

FIG. 3 is a flowchart of a method of modifying a color in a received signal in accordance with an embodiment of the present invention;

FIG. 4 is a functional diagram for illustrating an exemplary color management method, in accordance with an embodiment of the present invention;

FIG. 5 is a graph of exemplary gain values useable for modifying a received signal in accordance with an embodiment of the present invention.

### DETAILED DESCRIPTION

Aspects of the present invention are generally directed to expanding a color gamut for a received signal. A color gamut is the subset of colors, such as, for example, the range of colors capable of being reproduced on a display device or the range of colors capable of being represented when encoding or processing an image. Colors in a color gamut are typically represented using a color model. Exemplary color models include, for example, the RGB color model, the CMYK color model, and the YCbCr color model, among others. Color models typically use a plurality of components for representing a particular color in a color gamut. For example, the RGB color model uses three components: a red component, a green component, and a blue component, where the value of each of these components corresponds to how much of the corresponding color is to be included. A color gamut which is represented by a color model is often referred to as a color space.

As will be described in further detail below, in one embodiment, a display device or other component may receive a signal comprising an image for display by the display device. The data for the image(s) to be displayed is encoded in the received signal in accordance with a particular color gamut. The display device, however, may be capable of displaying colors in accordance with a different color gamut that may, for example, have a wider range of colors than the color gamut used to encode the image in the received signal. In one embodiment, a gain is applied to the component values for the colors in the received signal thereby expanding the displayed colors to those supported by the color gamut of the display device. As will be discussed in more detail below, the amount of gain to be applied to the received component values may be determined based on the particular component values in the received signal. For example, a large amount of gain may applied to colors on the edge of the color gamut (i.e., more highly saturated colors), while a smaller amount of gain (or no gain) is applied to component values corresponding to colors in the center of the color gamut (i.e., less saturated (more white) colors). In this manner, more highly saturated or vivid colors may be displayed by the display device using the display device's most highly saturated available colors, while natural or memory colors remain substantially the same. As used herein, the term “memory color” refers to a color that a viewer expects to be a certain color, such as, for example, skin tone. Typically, memory colors are those expected colors that are typically associated with less saturated colors.

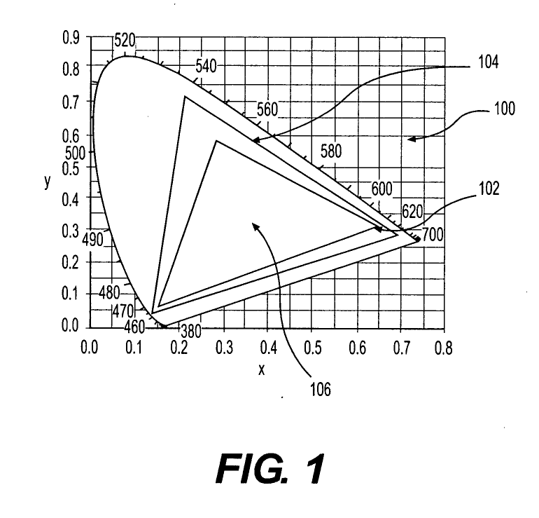

FIG. 1 illustrates two exemplary color gamuts represented as areas in the International Commission on Illumination (CIE) 1931 chromacity diagram 100. The CIE 1931 chromacity diagram is a common mechanism used for representing color gamuts known to those of skill in the art, and as such is not described further herein. As illustrated, FIG. 1 includes the International Telecommunication Union (ITU) Recommendation (REC) BT.709 (hereinafter referred to as “Rec 709”) color gamut 102 and an exemplary display's color gamut 104. Point 106 generally defines the region of each color gamut 102 and 104 for white colors. As known to those of skill in the art, Rec 709 is a high definition digital standard used for images and video, while a related analog ITU Rec BT.601 (“Rec 601”) is used for standard definition images and video.

As illustrated in FIG. 1, the display device's color gamut 104 has a wider range of color values than the REC 709 color gamut 102. Thus, in accordance with an embodiment of the present invention, if a video signal using color gamut 102 is sent to an exemplary display with color gamut 104, the color gamut 102 of the received image signal is expanded to take advantage of the improved display's color gamut 104. As will be described in more detail below, pursuant to an embodiment, this expansion may be accomplished by applying a gain to the colors in the image of the received signal. Further, the amount of applied gain may, for example, depend on the particular color in the image. For example, highly saturated colors (e.g., bright greens, reds, yellows, or blues) in the REC 709 color gamut 102 may have a high gain applied to them so that the colors are extended to the edge of the display's color gamut 104 when they are displayed; while, lower saturated colors (e.g., skin tones) may have a low or no gain applied to them so that when displayed they appear close to their original color. Note that while color gamut 104 is wider than color gamut 102 in the example of FIG. 1, in other applications a display may have a color gamut that shares an edge or is narrower on one side than the received signal's color gamut. Further, in an embodiment in which the display's color gamut is narrower on one or more edges than the received signal's color gamut, embodiments of the present invention may apply a gain (e.g., a variable gain) to shrink color values in these color gamut regions.

The following will provide a more detailed description of exemplary methods and systems for applying a gain to a color value in accordance with the teachings of the present invention. For purpose of illustration, exemplary embodiments are described with reference to a received signal in which an image (e.g., a digital video image) uses a color gamut represented by a YCbCr color model. In the YCbCr color model, Y refers to the brightness or luminance of the color, and Cr and Cb refer to the color component for the color. This color gamut may be, for example, any suitable color gamut, such as, for example, the above-discussed REC 709 color gamut. Further, in the following description a color gamut as represented by a YCbCr model will be referred to as a YCbCr color space. The YCbCr color space is also sometimes referred to as YUV, YPrPb (analog) or YDrDb (SECAM). However, in other embodiments, other color models (e.g., the RGB color model) may be used without departing from the present invention. Further, the received signal may be, for example, a signal transmitted in accordance with a standardized video format such as, for example, the Phase Alternating Line (PAL), National Television Standards Committee (NTSC), Advanced Television Systems Committee (ATSC) and Sequential Color with Memory (SECAM) standards, or a combination thereof. As used herein, the term color component refers broadly to any component that is representative of a particular color or representative of a particular color in conjunction with one or more other components. The color components, Cb and Cr, are often referred to as the blue chroma component, Cb, and the red chroma component, Cr, in the YCbCr color model.

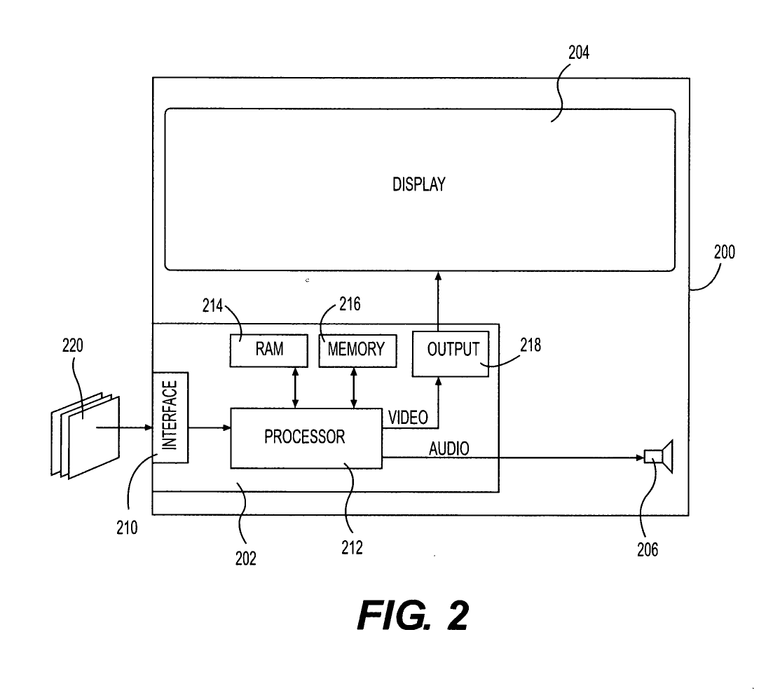

FIG. 2 illustrates a simplified block diagram of an exemplary television system 200, in accordance with an embodiment of the present invention. As illustrated, television system 200 may comprise a signal processing device 202, a display 204 and a speaker 206. Display 204 may be, for example, a liquid-crystal display (LCD), plasma display, projection display, cathode ray tubes (CRT), etc. Further, these components may be housed together or provided in separate components. For example, signal processing device 202 may be in a separate set-top box (STB) or computer, and speaker 206 may be, for example, an internal or external speaker system. Additionally, display 204 may be an external display, such as for example, an external LCD, plasma, or CRT display or, for example, a projection television comprising a projector and screen upon with video may be displayed.

As illustrated, signal processing device 202 may comprise a graphics interface 210, a processing device 212, a video memory 214, an operations memory 216, and a video output 218. Graphic interface 210 may be, for example, a type of I/O interface such as, for example, a serial, parallel, or video port, on any combination thereof. Exemplary video ports include, for example, a cable port, S-video interface, digital visual interface (DVI) connector, high-definition multimedia interface (HDMI) connector or combinations thereof. In operation, images 220 may be received by television system 200 through graphics interface 210 from a media source such as a broadcaster, computer, or storage device (DVD or hard disk). Images 220 may be, for example, static images or video images. Further, in addition to images 220, the data received by television system 200 via graphics interface 210 may also comprise audio data which may be processed by processing device 214 or sent directly to a suitable audio processor for reproduction by speaker 206. For simplification, the image portion (i.e., images 220) of the received data will be described herein without reference to the processing of the audio signal.

Processing device 212 may include, for example, any custom made or commercially available processor, graphics controller, central processing unit (CPU), auxiliary processor, microprocessor, application-specific integrated circuit (ASIC), a plurality of suitably configured digital logic gates and other electrical processing configurations, or any combination thereof.

Video memory 214 may comprise, for example, random access memory (RAM) such as, for example, video RAM (VRAM), Synchronous Graphic Random Access Memory (SGRAM), Double Data Rate-Synchronous DRAM (DDR-SDRAM), or other suitable RAM for graphical operations. In operation, when television system 200 receives images 220, processing device 212 may store the images in video memory 214 for processing by processing device 212. After which, processing device 212 may provide the processed image data to display 204 for display via video output 208. Video output 208 may be, for example, any interface capable of connecting signal processing device 202 to display 204. For example, video output 208 may included a cable port, S-video interface, digital visual interface (DVI) connector, high-definition multimedia interface (HDMI) connector or combinations thereof. Further, for example, video output 208 may connect signal processing device 202 to display 204 using one or more wires or other suitable means.

Operations memory 216 may comprise, for example, volatile memory elements such as RAM, DRAM, SRAM, etc., and/or nonvolatile memory elements such as read-only memory (ROM), flash memory, hard drives, CD-ROM, etc., or any combinations thereof. Further, operations memory 216 may store one or more modules, one or more look-up tables, an operating system, and other programs for operating signal processing device 202. For example, as will be discussed in further detail below, operations memory 216 may store a color management module that may be provided to and executed by processing device 212 to adjust the color values of received images 220 using, for example, a gain stored by operations memory 216 in a look-up table (LUT). This gain may be, for example, specific to the color gamut for display 204. Additionally, operations memory 216 may store a video converter that may be provided to and executed by processing device 212 for translating between color models. For example, in one embodiment, images 220 may use a YCbCr color space and display 204 may use an RGB color space and the stored video encoder/converter may be used by processing device 212 to convert the YCbCr component values of the received images 220 to RGB component values.

In alternative embodiments, a look-up table comprising other combinations of values may be implemented. For example, in alternative embodiments, a two-dimensional look-up table containing saturation and color, or a three-dimensional table containing saturation, color and brightness may be implemented in which table entries are (1) gain in saturation, (2) gain in CbCr, (3) gain in RGB, or (4) gain in xyz.

It should be noted that the illustrated television system 200 is a simplified functional diagram for explanatory purposes, and as such, may include additional components such as, for example, one or more audio ports, connectors for communicating with other processing boards, storage devices such as hard drive disks, user interface devices or additional processing devices and/or memory. Further, in some embodiments, video memory 214 and operations memory 216 may be shared components.

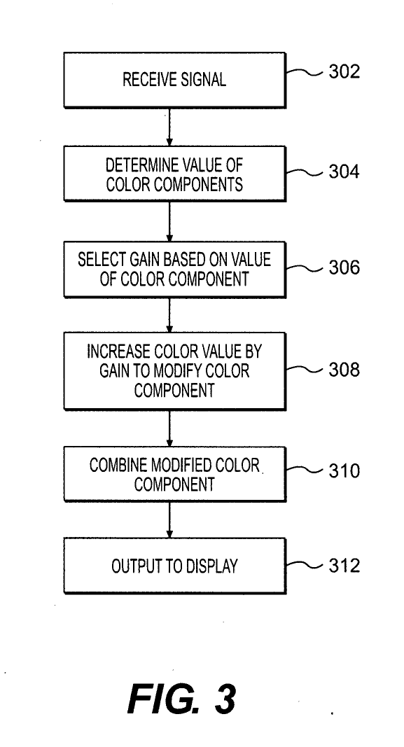

FIG. 3 is a flowchart of an exemplary color management method in accordance with an embodiment of the present invention. FIG. 3 will be described next below with reference to FIG. 2 in the context of television system 200 that receives a video signal including images 220 that are to be displayed on display 204. Images 220 are encoded using a YCbCr color model. However, in other embodiments the received images 220 may be encoded using other color models, such as, for example, an RGB color model. Further, the received video signal may be encoded using a color gamut, such as, for example, the noted REC 709 color gamut.

At block 302, a video signal comprising images 220 is received by graphics interface 210. Graphics interface 210 provides the received video signal to processing device 212. At block 304, processing device 212 processes the received video signal to obtain images 220 and to determine the separate color components, Cr and Cb, for each pixel of each image 220. Processing device 212 may then use the determined color components to look up a corresponding gain in a look-up table (LUT). This LUT may be stored by operations memory 216 such that corresponding gains are stored for each possible color in the color gamut used for encoding images 220. Further, the LUT may store a corresponding gain for each color component, Cb and Cr, or one common gain to be applied to both components, Cb and Cr, based on their respective values.

The gains corresponding to particular color component values, Cb and Cr, may be determined, for example, based on testing the color gamut of the display. Alternatively, the gain(s) for a particular color component value, Cb and Cr, may be determined based on the distance the color component value(s), Cb and Cr, is/are from the white portion of the color gamut (e.g., the display's or encoded image's color gamut). In one embodiment, more saturated colors (i.e., where the color components Cr and Cb have higher values) may have larger gain values applied to them to push these more saturated color values to the edges of the color gamut for the display 204. Color components with lower color value (i.e., those closer to white) have smaller corresponding gains (e.g., 1 or close to 1). Thus, the stored LUT may store different gain values for different values of color components. That is, two different colors in a received image 220 may have different gains applied to them depending on the color values.

At block 308, processing device 212 may then apply the determined gain to the color components. In one embodiment, processing device 212 multiplies the color components, Cb and Cr, by the corresponding determined gain for each color component, Cb and Cr. For example, if a pixel in an image initially has color components Cb=75 and Cr=32, and the LUT stores a corresponding gain for this pair of color components of 1.5 and 1.1, respectively, then processing device 212 may apply the gains by multiplying the gains and their corresponding component value (Cb′=75*1.5=112 and Cr′=32*1.1=35) to obtain the new color component values, Cb′ and Cr′.

Next, processing device 212 may combine the modified color components with the luminance component, Y, at block 310. For example, as noted above, in the present embodiment, no gain is applied to the luminance value, Y. This modified image with component values, Y, Cb′ and Cr′, may then be provided to display 204. Further, in an embodiment, processing device 212 may execute an optional converter to convert the color components to a different color space. For example, in an embodiment, display 204 may use an RGB color space and processing device 212 may convert the luminance value, Y, and modified color components Cb′ and Cr′ to RGB color component values, which it may then provide to display 204 for displaying the image.

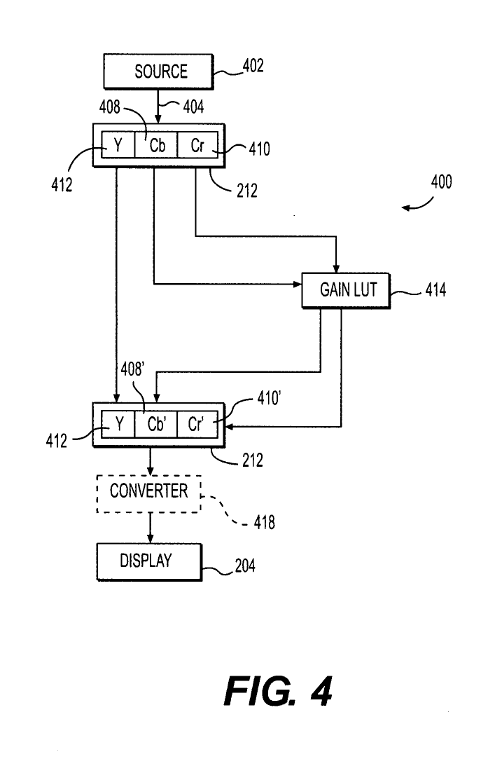

FIG. 4 is a functional diagram for illustrating an exemplary color management method, in accordance with an embodiment of the present invention. FIG. 4 will be described with reference to the above-noted FIGS. 2 and 3. A source 402, such as for example, a broadcast source, produces image data and that is sent via a signal 404 that is received by graphics interface 210 of television system 200 and provided to processing device 212. Processing device 212 then determines the color values for the Cb color component 408 and Cr color component 410 of a pixel in the image 220 of the received signal 404. Processing device 212, however, in the present embodiment, need not process the luminance component Y 412, for the pixel.

A look-up table (LUT) 414 may then be accessed by processing device 212 to determine corresponding gain values to be applied to the color components 408 and 410. The obtained gains from LUT 414 may then be applied to color components 408 and 410 to obtain modified color components 408′ and 410′, respectively. As noted above, the gain values may be determined based on the color gamut of the display and applied by multiplying the original color components by the determined gain(s).

Once the gain is applied, the modified color components 408′ and 410′ may be combined with luminance component 412 by processing device 212 and provided to display 204 for displaying the image. In some embodiments, an optional video converter 418 may be connected to processing device 212 to convert the YCr′Cb′ component values into another color space, such as an RGB color space, prior to providing the modified values to display 204.

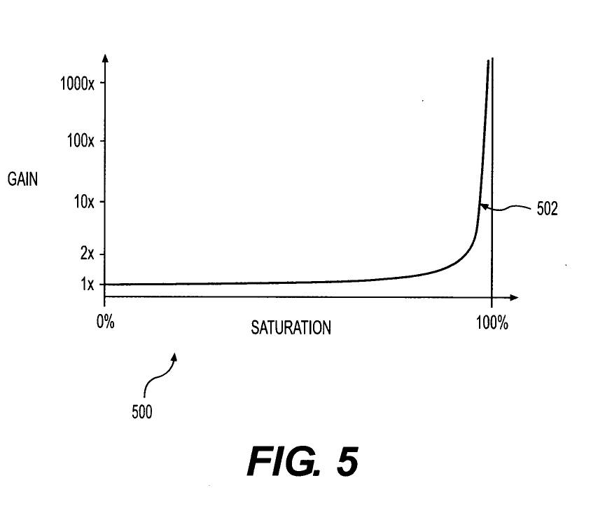

Although FIGS. 2-4 are discussed above with reference to using a LUT to determine the corresponding gain value(s) for the color components of a pixel of an image to be displayed, in other embodiments a gain function may be used to determine the gain value to be applied. FIG. 5 provides an exemplary graph 500 of saturation levels versus gain of an exemplary function that may be used for determining the gain to be applied to a particular color component value. As illustrated, gain 502 increases at a non-constant or exponential rate depending on saturation (i.e., the value for a particular color component), such that at low saturation values the gain to be applied is 1 and at high saturation values the gain increases exponentially. Thus, using gain 502 the color components in the received signal that are highly saturated will have a higher gain applied to them, while less saturated colors will remain relatively unaffected by a lower gain. Such embodiments may advantageously provide both bright and vivid colors without significantly altering less saturated colors.

For example, color values that are less than 80% saturation (i.e., the value for the color component is less than 80% of the maximum value for the particular color gamut) will have little to no gain applied. Color values that are between 80% and 95% saturation will have a gain applied that increases the color value by a factor of 1 to 10. For color values that are highly saturated, above 95%, the gain may be a multiplier that increases the color value by a factor of greater than 10, such that the color value for the color component is increased to the maximum color value for a corresponding color in the display's color gamut. As such, gain 502 may expand the color gamut for the received images in a non-linear fashion to the edges of the display's color gamut, while maintaining colors near the center of color gamut.

The exemplary function illustrated by graph 500 may be, for example, implemented by a mathematical formula executed by a color management module executed by a processor. Or, for example, the function of graph 500 may be used to generate gain values stored by a corresponding stored LUT. It should also be noted that although FIG. 5 illustrates a 2-dimensional function that may be useable to determine a corresponding gain for a particular component value, in other embodiments a multi-dimensional function may be used that may determine corresponding gains for a plurality of color component values. For example, in an RGB color space, a multi-dimensional function may be used to determine corresponding gains for each of the three color components, R, G, and B, based on the collective values of the three color components.

Although the present invention has been fully described in conjunction with several embodiments thereof with reference to the accompanying drawings, it is to be understood that various changes and modifications may be apparent to those skilled in the art. For example, it should be appreciated by one of ordinary skill in the elements described above with reference to functional block diagrams may comprise more or less components than those illustrated or described, and that the functional divisions described herein are conceptual only and are provided to facilitate understanding of embodiments of the present invention. Such functional allocations, therefore, should not be construed as limiting in any way. Such changes and modifications are to be understood as included within the scope of the present invention as defined by the appended claims, unless they depart therefrom. The present embodiments are, therefore, to be considered in all respects as illustrative and not restrictive.

What is claimed is:

1. A method for managing colors for a display, comprising:
receiving a signal corresponding to an image to be displayed, the received signal comprising a color component having a color value;
determining a gain based on the color value;
applying the determined gain to the color value to generate a modified color value for the color component; and
displaying the image using the modified color value.

2. The method of claim 1, wherein receiving the signal corresponding to the image to be displayed comprises:
receiving a plurality of pixels for the image, each of the plurality of pixels having a color component.

3. The method of claim 1, further comprising:
selecting the color component from a set of a blue color component (Cb) and a red color component, (Cr) of a YCbCr color model; and
generating the signal containing the selected color component.

4. The method of claim 1, wherein applying the determined gain to the color value comprises:
multiplying the determined gain and the color value to generate the modified color component.

5. The method of claim 1, further comprising:
obtaining the gain from a data table stored in a computer memory device.

6. The method of claim 1, wherein the received signal comprises a first color component having a first color value and second color component having a second color value, the method further comprising:
applying a first gain to the first color value to generate a modified first color value; and
generating a modified second color value for the second color value by applying a second gain to the second color value, wherein the first gain is different than the second gain.

7. The method of claim 1, wherein the display has a color gamut and the signal is encoded using a color gamut, wherein the display's color gamut comprises a wider range of available colors than the signal's color gamut.

8. The method of claim 1, wherein the signal is a video signal.

9. A system comprising:
a graphics interface configured to receive a signal corresponding to an image to be displayed, the received signal comprising a color component having a color value;
a processor configured to generate a modified color value for the color component by applying a gain to the color value, wherein the gain is based on the color value; and
an output configured to send the image to be displayed using the modified color value for display by a display.

10. The system of claim 9, wherein the image comprises a plurality of pixels, and wherein the color component corresponds to a pixel of the plurality of pixels.

11. The system of claim 9, wherein the signal is uses a YCbCr color model, and wherein the color component is selected from the set of: a blue color component, Cb, and a red color component, Cr.

12. The system of claim 9, wherein the processor in applying the gain is configured to multiply the gain and the color value.

13. The system of claim 9, further comprising:
a storage storing a table storing a plurality of color values and a corresponding gain for each of the plurality of color values; and
wherein the processor is further configured to determine the applied gain by obtaining a corresponding gain for the color value from the stored table.

14. The system of claim 9, wherein the received signal comprises a first color component having a first color value and second color component having a second color value, and wherein the processor is further configured to generate a modified first color value for the first color value by applying a first gain to the first color value, and generate a modified second color value for the second color value by applying a second gain to the second color value, wherein the first gain is different than the second gain.

15. The system of claim 9, wherein the signal is encoded using a color gamut and the display has a color gamut, and wherein the display's color gamut comprises a wider range of available colors than the signal's color gamut.

16. The system of claim 9, wherein the received signal is a video signal and the display is a television.

17. A system, comprising:
means for receiving a signal corresponding to an image to be displayed, the received signal comprising a color component having a color value;
means for determining a gain based on the color value;
means for applying the determined gain to the color value to generate a modified color value for the color component; and
means for displaying the image using the modified color value.

18. The system of claim 17, wherein the image comprises a plurality of pixels, and wherein the color component corresponds to a pixel of the plurality of pixels.

19. The system of claim 17, wherein the signal is generated using a YCbCr color model, and wherein the color component is selected from the set of: a blue color component, Cb, and a red color component, Cr.

20. The system of claim 17, wherein the means for applying the determined gain to the color value comprises:
means for multiplying the determined gain and the color value to generate the modified color component.

21. The system of claim 17, further comprising:
means for obtaining the gain from a stored table.

22. The system of claim 17, wherein the received signal comprises a first color component having a first color value and second color component having a second color value, the system further comprising:
means for generating a modified first color value for the first color value by applying a first gain to the first color value; and
means for generating a modified second color value for the second color value by applying a second gain to the second color value, wherein the first gain is different than the second gain.

23. The system of claim 17, wherein the display has a color gamut and the signal is encoded using a color gamut, wherein the display's color gamut comprises a wider range of available colors than the signal's color gamut.

24. The system of claim 17, wherein the signal is a video signal.
